(19) United States
(12) Patent Application Publication
(10) Pub. No.: US 2014/0181096 A1
(43) Pub. Date: Jun. 26, 2014

(54) ENTITY NAME DISAMBIGUATION

(71) Applicant: MICROSOFT CORPORATION, Redmond, WA (US)

(72) Inventors: Wei Zhuang, Sammamish, WA (US); Jisheng Liang, Bellevue, WA (US)

(73) Assignee: Microsoft Corporation, Redmond, WA (US)

(21) Appl. No.: 13/723,592

(22) Filed: Dec. 21, 2012

(51) Int. Cl. G06F 17/30

(52) U.S. Cl. CPC G06F 17/3053
USPC 707/727; 707/722; 707/723

(57) ABSTRACT

Systems, methods, and computer-readable storage media for disambiguating entity names by determining query terms to associate with certain entities based on, for instance, user selection of Uniform Resource Locators (URLs), are provided. In embodiments, query data is analyzed to determine which queries are most closely associated with certain entities, based on quantities of user selections associated with a particular URL and a given query, as compared to a total quantity of user selections associated with the query. Identified queries can be used to return search results, images to supplement search results, advertising, or the like that are associated with appropriate entities.

### BACKGROUND

In formulating requests for information, for instance, in formulating search queries for searches of networked resources such as searches conducted using the Internet, entities are often referred to ambiguously, and a request for information about one entity often results in information pertaining to multiple entities having similar or identical entity names. As users are generally looking for information about only one of the multiple entities, much of the information returned as a result of the information request is not relevant to the user.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable storage media for disambiguating entity names by identifying query terms associated with certain entities (such as people, places, or products, among other things) based on, for instance, user selection of Uniform Resource Locators (URLs). Queries are analyzed based on user selection of a particular URL, a quantity of user selections associated with the particular URL, and a total number of user selections of other URLs, in response to execution of the query. Once a particular query is associated with a particular URL and, accordingly, with a particular entity, upon receipt of the particular query, information (e.g., search results, images to supplement search results, advertising, or the like) that is associated with the appropriate entity may be returned providing more relevant information to the user.

### BRIEF DESCRIPTION OF THE DRAWINGS

The present invention is illustrated by way of example and not limited in the accompanying figures in which:

FIG. 1 is a block diagram of an exemplary computing environment suitable for use in implementing embodiments of the present invention;

FIG. 2 is a flow diagram showing an exemplary method of associating query information and click count information with URLs, in accordance with an embodiment of the present invention;

FIG. 3 is a flow diagram showing an exemplary method of determining a dedication ratio for a URL with respect to a query, in accordance with an embodiment of the present invention;

FIG. 4 is a flow diagram showing an exemplary method associated with determining a dedication score for a query, in accordance with an embodiment of the present invention;

FIG. 5 is a flow diagram showing an exemplary method associated with determining queries and associated counts, in accordance with an embodiment of the present invention;

FIG. 6 is a flow diagram showing an exemplary method for determining dedication ratios, in accordance with an embodiment of the present invention;

FIG. 7 is a flow diagram showing an exemplary method for determining dedication scores, in accordance with an embodiment of the present invention;

FIG. 8 is a flow diagram showing an exemplary method for determining dedication scores, in accordance with an embodiment of the present invention;

FIG. 9 is a schematic diagram showing an exemplary association of data with a Uniform Resource Locator, in accordance with an embodiment of the present invention; and

FIG. 10 is a schematic diagram showing an exemplary interface, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document in conjunction with other present or future technologies. Although the terms “step” and/or “block” may be used, the terms should not be interpreted as implying any particular order among or between various steps herein disclosed. Various aspects of the technology described herein are generally directed to systems, methods, and computer-readable storage media for, among other things, identifying queries that correspond to certain items or entities. In embodiments, items or entities can include objects such as people, places, characters, and products, such as goods or services, etc., as more fully described below.

Embodiments of the present invention associate search queries or search query terms with particular entities. Multiple entities (that is, entity identifiers) and multiple website addresses (Uniform Resource Locators or URLs) are received by the system. At least a portion of the received website addresses are associated with a particular entity. To identify a particular entity associated with a particular website address (and thus with a particular entity), the system logs search terms and selections made by users, and associates particular search terms with particular entities based on the user selections. In an embodiment, a quantity of user selections of particular website addresses are logged. An identity of a user (or client computing device) making a user selection may also be logged such that a maximum quantity of user selections made by the same user or client computing device may be logged, if desired. In embodiments, information is selected for display based on a search term and its association with a particular website address and, thus, a particular entity.

As more fully described below, embodiments include computer-readable storage media storing instructions that cause one or more devices to select a disambiguated name for an entity. A server, indexer, or crawler-type component receives web pages associated with entities and a set of queries associated with the web pages. The entities may be proper nouns, people, places, characters, titles, slogans, or products, or the like. Such entity identifiers are not intended to limit the scope of embodiments of the present invention, however. Any and all such variations, and any combination thereof, are contemplated to be within the scope of embodiments hereof. In an exemplary embodiment, a first search query is identified as associated with a particular URL (and thus a particular entity) based on user selections of web pages after the first query has been executed. In embodiments, user selections may be weighted.

In embodiments, the first query may be ranked as the highest query associated with an entity, and at least a portion of the query may be stored as a disambiguated name for the entity. The first query can be ranked higher, in embodiments, based on a first quantity of user selections of a particular web page compared to a second quantity of user selection of one or more other web pages associated with the first query. In embodiments, the first query may be used to retrieve an image for display. The image can supplement or accompany search results based on another query, such as a similar or related query, in order to provide an image associated with a particular entity.

In another embodiment, a method for identifying one or more search queries includes receiving a plurality of queries, including a first query, and receiving a plurality of URL selections associated with at least the first query. A subset of URL selections is determined for the first query, and a quantity of user selections that correspond to a first URL selection is determined. A ratio is determined of (1) the quantity of user selections corresponding to the first URL selection to (2) the total quantity of user selections associated with the query (the total quantity available in memory or within the relevant server logs, etc.). Either quantity of user selection may be filtered for noise and/or to filter the quantity of user selections origination from the same user or client computing system. In embodiments, a score is determined for each query with respect to the URL “Uᵢ.” The score may be determined by multiplying each ratio by the quantity of user selections corresponding to the first URL selected.

For a second query, a second subset of URL selections is determined, which also includes the first URL selection (mentioned above). The quantity of URL selections corresponding to the first URL selection and the second query is determined. A second ratio is determined, which is the quantity of user selections compared to a total quantity of URL selections associated with the second query. A score is determined for the second query based on multiplying the second ratio by the quantity of URL selections corresponding to the first URL selection and the second query (determined above). The first and second queries may then be ranked relative to one another based on their respective scores. In response to a request for information about an entity or related to an entity, the first query can be executed. The request for information can be a request for an advertisement, such as a link, image, or product placement. A request can be made by a user or automatically by code or other instructions, based on an available advertising space in embodiments.

Accordingly, in one embodiment, a system is provided for associating search terms with entities. The system includes an entity-receiving component that receives a plurality of entities; an address-receiving component that receives a plurality of addresses, each of the plurality of addresses being associated with one of the plurality of entities; a logging component that logs one or more submitted search terms and one or more user selections; and an associating component that associates a first search term of the plurality of search terms with a first entity of the plurality of entities based on the one or more user selections.

In another embodiment, the present invention is directed to one or more computer-readable storage media storing computer-useable instructions that, when used by one or more computing devices, cause the one or more computing devices to perform a method for selecting a disambiguated name for an entity. The method includes receiving a plurality of web pages, each of at least a portion of the plurality of web pages being associated with a respective entity of a plurality of entities; receiving a plurality of search queries, each of at least a portion of the plurality of search queries being associated with a respective one of the plurality of web pages; determining that a first search query of the plurality of search queries is associated with a first entity based on one or more user selections of an associated web page of the plurality of web pages in response to execution of the first search query; ranking the first search query as the highest ranked search query associated with the first entity; storing said first search query as the disambiguated name for the first entity.

In yet another embodiment, the present invention is directed to one or more computer-readable storage media storing computer-useable instructions that, when used by one or more computing devices, cause the one or more computing devices to perform a method for identifying one or more search queries. The method includes receiving a plurality of queries including a first query; receiving a plurality of URL selections, each of the plurality of URL selections being associated with at least one query of the plurality of queries; for the first query, determining a first subset of URL selections; for a first URL selection of the first subset of URL selections, determining a first quantity of URL selections that correspond to the first URL selection and to the first query; and determining a first ratio of the first quantity of URL selections to a total quantity of URL selections associated with the first query.

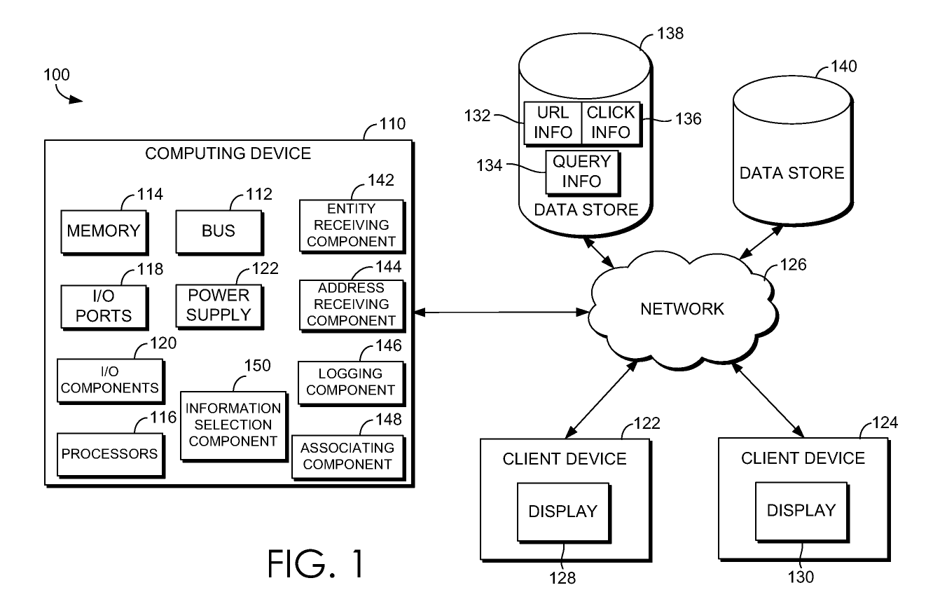

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules including routines, programs, objects, components, data structures, and the like, and/or refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 112 that directly or indirectly couples the following devices: a memory 114, one or more processors 116, input/output (I/O) ports 118, one or more I/O components 120, and an illustrative power supply 122. The bus 112 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterates that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 110 typically includes a variety of computer-readable media. Computer-readable media may be any available media that is accessible by the computing device 110 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 110.

Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 114 includes computer-storage media in the form of volatile and/or nonvolatile memory. The memory may be removable, non-removable, or a combination thereof. Exemplary hardware devices include solid-state memory, hard drives, optical-disc drives, and the like. The computing device 110 includes one or more processors that read data from various entities such as the memory 114 or the I/O components 122. The computing device 110 can be in communication with exemplary client devices 122 and 124 through any type of wired or wireless connection 126, including the Internet or an intranet.

The I/O ports 118 allow the computing device 110 to be logically coupled to other devices including the I/O components 120, some of which may be built in. Illustrative components include a microphone, joystick, game pad, satellite dish, scanner, printer, wireless device, and the like. Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “search engine” may be utilized used herein, it will be recognized that this term may also encompass a server, a Web browser, a set of one or more processes distributed on one or more computers, one or more stand-alone storage devices, a set of one or more other computing or storage devices, a combination of one or more of the above, and the like.

The client devices 122 and 124 include interface displays 128 and 130, respectively. Exemplary interface displays include screens, speakers, printing components, and the like. The interface displays 128 and 130 may be remote from client devices 122 and 124. In an embodiment, computing device 110 has access to stored information, including source or entity URL information 132, query information 134, and click count information 136. The entity URL information 132, query information 134, and the click count information 134 can be stored at the computing device 110, or made available based on a connection to, or request from, the computing device 110. The information can be remote, from a third-party, or anonymous, and it can be obtained at any time.

In an embodiment, the query information 134 and click count information 136 are obtained or requested from one or more remote databases 138, 140. As illustrated, the computing device 110 includes an entity-receiving component 142, an address-receiving component 144, a logging component 146, an associating component 148 and an information selection component 150. One or more components described herein can be located on one or more computing devices, such as computing device 110, which can be distributed and/or available through remote connections.

As previously mentioned, embodiments of the present invention relate to systems, methods, and computer-readable storage media for, among other things, determining a query that corresponds to an entity. As discussed above, an item or entity can include objects such as people, places, characters, and products, such as goods or services. In one example, for the entities Will Smith (the actor) and Will Smith (the football player), preferred or effective queries are determined. For example, the highest ranked query for Will Smith (the actor) may be “Will Smith,” while the highest ranked query for Will Smith (the football player) may be “Will Smith defensive end.” These queries can be ranked based on the amount of times that users selected certain URLs, which are associated with certain entities, after submitting queries for one of the Will Smith entities.

In embodiments, certain URLs are known to be associated with certain entities, based on prior analysis, crawling, tagging information, or other stored information. These URLs can be considered entity URLs 132, or “source URLs,” with higher-quality content about the entity or a higher-confidence match with the correct entity (e.g., the URL for the actor Will Smith's official web page). These entity URLs 132 can be manually selected or selected based on search terms, which may later be refined by user feedback or other input. Server logs or other stored user-behavior information is analyzed for user's query information 134 and “click count” information 136 in embodiments of the present invention.

As shown below in Table 1, an analysis is performed for each “source URL” 132 represented by “Uᵢ,” whereby all of the query information 134 associated with U, in the server logs (or other memory associated with executed searches and accessibly by computing device 110) is analyzed. Each query that was executed and resulted in a user selection of the URL “Uᵢ” is analyzed to determine how many user selections occurred, from Query 1 (“Qᵢ”) through any quantity of queries. The quantity of user selections of the URL “Uᵢ” after each query is shown in column three (“Count”), and it is based on click count information 136. This count can be filtered to eliminate noise or multiple user selections from the same device (such as client devices 122 and 124), or to eliminate multiple selections from the same account or household. Additionally, the count can include weighted user selections based on a user's own account or history, users who speak the same language or live in a certain area, users with demographic commonalities, or other user or user-device activity. The click count does not necessarily involve literal “clicks” by a mouse; the click count indicates the quantity of user selections of certain web pages, links, or addresses by any method, including tapping, holding, voice commands, etc. The associations shown in Table 1 can be determined by computing device 110 for multiple URLs, based on query information 134 and click count information 136.

TABLE 1
A URL “Ui” associated with an entity organized by
queries and click counts.

| URL | Query | Count |
|---|---|---|
| Uᵢ | Q₁ | C₁ |
| Uᵢ | Q2 | C2 |
| Uᵢ | . . . | . . . |
| Uᵢ | Qₘ | Cₘ |

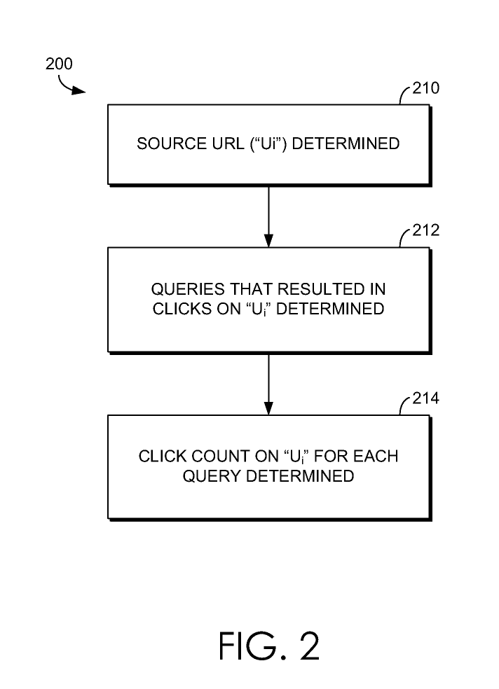

Referring now to FIG. 2, an exemplary method 200 is illustrated for associating query information 134 and click count information 136 with URLs as shown in Table 1, in accordance with an embodiment of the present invention. As indicated at block 210, a source or entity URL (here “Uᵢ”) is determined. Queries associated with “Uᵢ” are determined, as indicated at block 212. The associated queries can be queries that led to clicks on “Uᵢ” according to logged information, such as logs accessed by computing device 110. As indicated at block 214, the click count (shown under “Count”) for each query is determined. In an embodiment, the click count information 136 indicates how many times “Uᵢ” was selected for each query (“Q1,” “Q2,” etc.).

As shown in Table 2 below, for each query (e.g., “Q1”), the corresponding URL and click count information 136 is determined and shown in columns two and three. In the last column, a dedication ratio is determined for the query with respect to each URL. The dedication ratio can indicate how closely a query is associated with a URL, including a source or entity URL. The dedication ratio is determined according to a formula, where the dedication ratio is equal to the click count for one URL divided by the sum of click counts for all URLs associated with the same query. For example, the dedication ratio Rᵢ, 1 is based on dividing C₁ (the click count for the first URL) by the sum of all click counts for Q1 (for any URL). The associations shown in Table 2 can be determined by a computing device 110 for query “Qi” and multiple URLs. The amount of URLs or table entries or fields shown in Tables 1, 2 and 3 are scalable up to any amount. The associations in Table 2 can be determined for multiple queries based on query information 134 and click count information 136.

TABLE 2
Queries associated with URLs, click counts,
and a dedication ratio.

| | | | Dedication |
|---|---|---|---|
| Query | URL | Count | Ratio |
| Qᵢ | U₁ | C₁ | Rᵢ, 1 |
| Qᵢ | U₂ | C₂ | Rᵢ, 2 |
| Qᵢ | . . . | . . . | . . . |
| Qᵢ | Uₙ | Cₙ | Rᵢ, n |

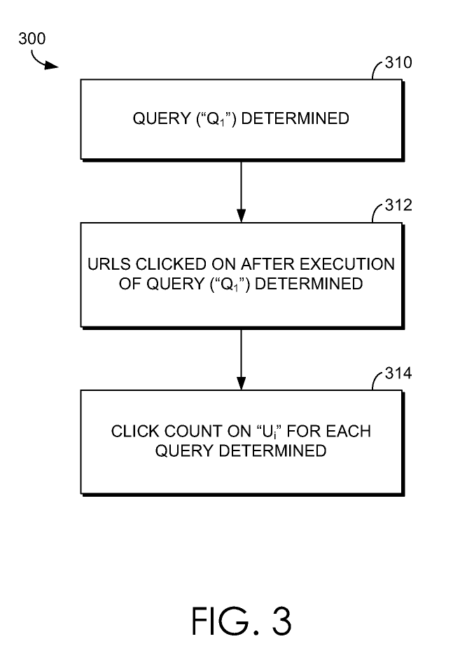

With reference to FIG. 3, an exemplary method 300 is shown for determining a dedication ratio for a URL with respect to a first query, in accordance with an embodiment of the present invention and exemplary Table 2. As indicated at block 310, a particular query is selected or determined (e.g., “Qᵢ”). As indicated at block 312, each URL that has been selected after the execution of the query “Qᵢ” (according to query information 134 and click count information 136) is determined and populated in Table 2 at column 2. The selected-URL data is associated with the corresponding quantity of counted user selections (clicks), as indicated at block 314.

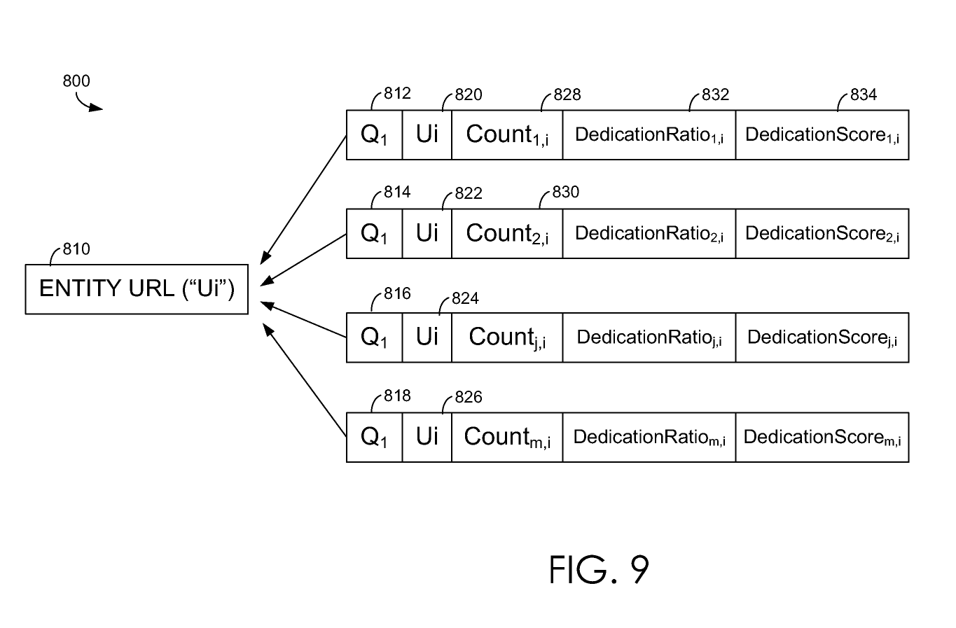

As shown in Table 3 below, a selected or clicked-on URL, such as “Uᵢ,” is associated with each query that was executed and resulted in a click on, or a user selection of, “Uᵢ.” The URL “Uᵢ” is also associated with a click count, as shown in column three of Table 3, and a dedication ratio (column four) and a dedication score (column five), discussed below. The data associations stored in Table 3 can be determined and repeated by a computing device for multiple queries (an unlimited amount from “Qᵢ” through “Qₘ”) and multiple URLs. As more fully described with respect to FIG. 9 below, the queries (812, 814, 816, 818) can be stored in association with an entity URL 810 and associated with each query's URL, count, dedication ratio, and dedication score information, such as dedication ratio 832 and dedication score 834, which are associated with query Q₁.

TABLE 3
URL “Uᵢ” associated with queries, click counts,
dedication ratios, and dedication scores.

| | | | Dedication | Dedication |
|---|---|---|---|---|
| URL | Query | Count | Ratio | Score |
| Uᵢ | Q₁ | C₁ | R₁, i | Score 1 |
| Uᵢ | Q₂ | C₂ | R₂, i | Score 2 |
| Uᵢ | . . . | . . . | . . . | . . . |
| Uᵢ | Qₘ | Cₘ | Rₘ, i | Score m |

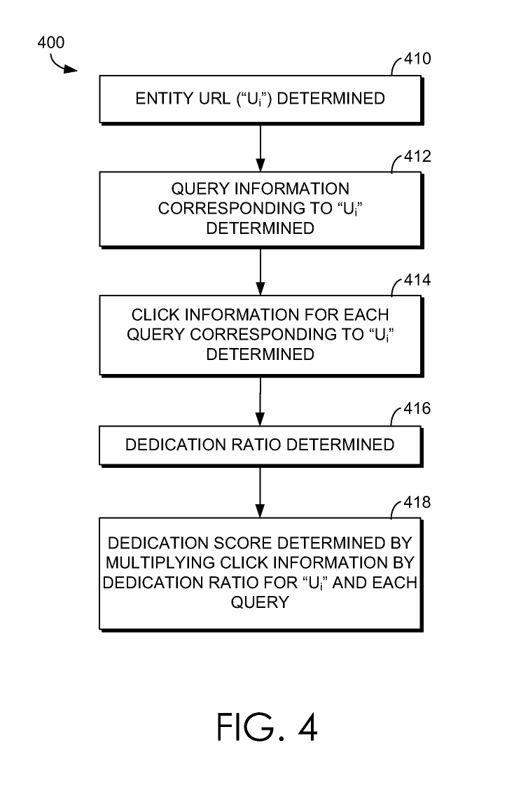

With reference to FIG. 4, illustrated is an exemplary method 400 associated with determining a dedication score, in accordance with an embodiment of the present invention and exemplary Table 3. As indicated at block 410, the URL “Uᵢ” is identified or determined. The query information 134 is determined and organized with respect to the URL “Uᵢ” as indicated at block 412. As indicated at block 414, the click count information 136 is determined for each query associated with “Uᵢ” in the table. As indicated at block 416, the dedication ratio as described in Table 2 and FIG. 3 is determined. Determining the information can mean populating the appropriate fields or sorting the information according to the criteria (such as entity URLs and click counts). As indicated at block 418, a dedication score is determined by multiplying the click “Count” number in column three by the dedication ratio in column four. In one example, as determined by computing device 110, query “Q1” has a count of 100 for the URL “Uᵢ,” but it only has a dedication ratio of 0.1, resulting in a dedication score of 10. On the other hand, in this example, query “Q₂” has a click count of 2 but a dedication ratio of 100, resulting in a higher dedication score of 20.

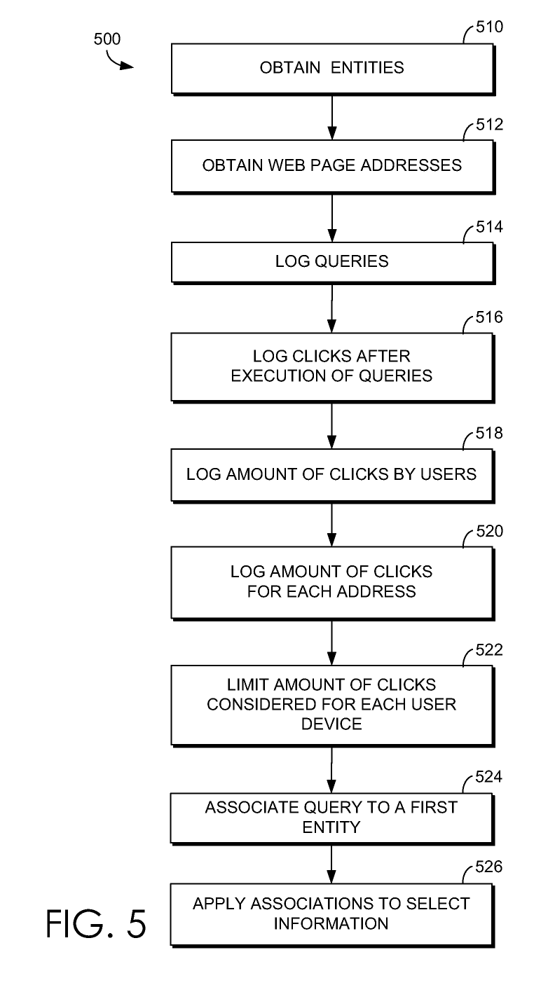

Turning now to FIG. 5, illustrated is an exemplary method 500 implemented by a computing system for associating search terms with entities, in accordance with an embodiment of the present invention. The system includes an entity-receiving component (shown at 142 of FIG. 1) that is configured to receive a plurality of entities, as indicated at block 510. An address-receiving component (shown at 144 of FIG. 1) is configured to receive a plurality of addresses, as indicated at block 512, where each address is associated with one of the plurality of entities. In this embodiment, a logging component 146 is configured to log search terms submitted to computer programs, applications or servers, as indicated at block 514. As indicated at block 516, the logging component logs selections made by one or more users.

In embodiments, the logging component 146 is further configured to log the quantity of the selections made by the users (as indicated at block 518), and to log a quantity of user selections for each of the one or more addresses (as indicated at block 520). In embodiments, the logging component 146 is also configured to log a quantity of user selections for each of the addresses based on considering a limited number of user selections for each of the client computing devices 122 and 124, as indicated at block 522. Selections from a client computing device can be filtered to limit the quantity of clicks considered per user or per user computer, or to limit non-unique or repeat visits. The clicks can be removed or filtered at the time of counting or data collection, or at the time that the quantity of clicks are considered (in other words, the clicks can be collected and filtered at a later time).

The exemplary system includes an associating component (shown at 148 of FIG. 1) configured to associate a first search term with a first entity based on the one or more user selections, as indicated at block 524. The associated search term can be utilized to select information for transmission and/or display, as indicated at block 526, such as a prominent search result, an image, or an advertisement. In an embodiment, the logging component 146 is present on one or more servers and can include historical logging, while one or more other components, such as the entity-receiving component 142, are present on one or more additional servers. Servers can include one or more computing devices, such as device 110, in a distributed or non-distributed configuration.

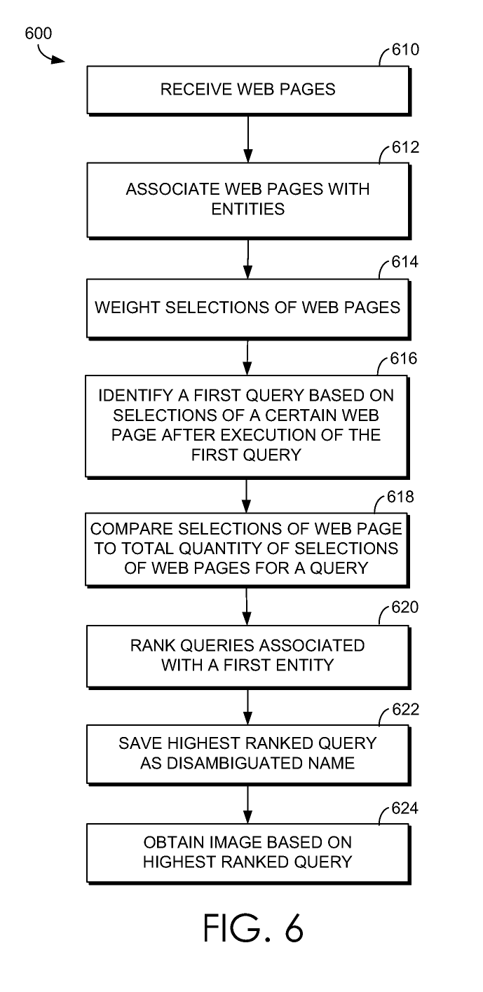

With reference to FIG. 6, illustrated is an exemplary method 600 for selecting a disambiguated name for an entity, in accordance with an embodiment of the present invention. When an entity name can be ambiguous, the exemplary method can be used by a computing device (e.g., computing device 110 of FIG. 1) to select a disambiguated name. In one example, for the ambiguous entity “Will Smith,” the disambiguated name is “Will Smith defensive end.” A set of web pages is received (as indicated at block 610), and the web pages are associated with entities, including a first entity (as indicated at block 612). As shown at block 614, selections of web pages after viewing results from a search query are weighted in embodiments. For example, a return visit to a web page after execution of a query can be weighted more heavily, thereby contributing to that query being more closely associated with the first entity. Selection made by a certain user, such as a present user, can be weighted, as can selections made by users in the same country or users that speak the same language as the present user.

A first query is determined from a set of queries associated with the first entity, based on selections of a first web page after an execution of a query, as indicated at block 616. The selections of certain web pages after execution of a query can be stored in server logs, derived from server or search query logs, or obtained from other databases, such as databases (e.g., databases 138, 140 of FIG. 1). The first query or any query analyzed according to embodiments of the present invention can be a partial or parsed query that represents a portion of a user query.

As indicated at block 618, the first and highest ranked query according to an embodiment is determined, based on comparing the quantity of selections of a first web page to a quantity of selections of the other web pages combined with the first quantity selections (in other words, comparing the quantity of selections of a first web page to the quantity of all selections of web pages for a particular query). The first query is ranked as the highest ranked query associated with the first entity in an embodiment, as indicated at block 620. The ranking can be based on selections of one or more certain web pages or website addresses after executing queries. The ranking can also be based on other factors or considerations, alone or in combination, such as click count information 136, and dedication ratios and/or scores based on click count information 136. As indicated at block 622, the first query is stored as the disambiguated name for the first entity.

In embodiments, the first query can be used to retrieve an image for display, as indicated at block 624 (for instance, utilizing information selection component 150 of FIG. 1). For example, a user may perform a search for “Will Smith football.” One or more search results may be based on the query “Will Smith football,” but, on the other hand, as indicated at block 624, an image that is requested and presented for display could be obtained using the disambiguated query “Will Smith defensive end.”

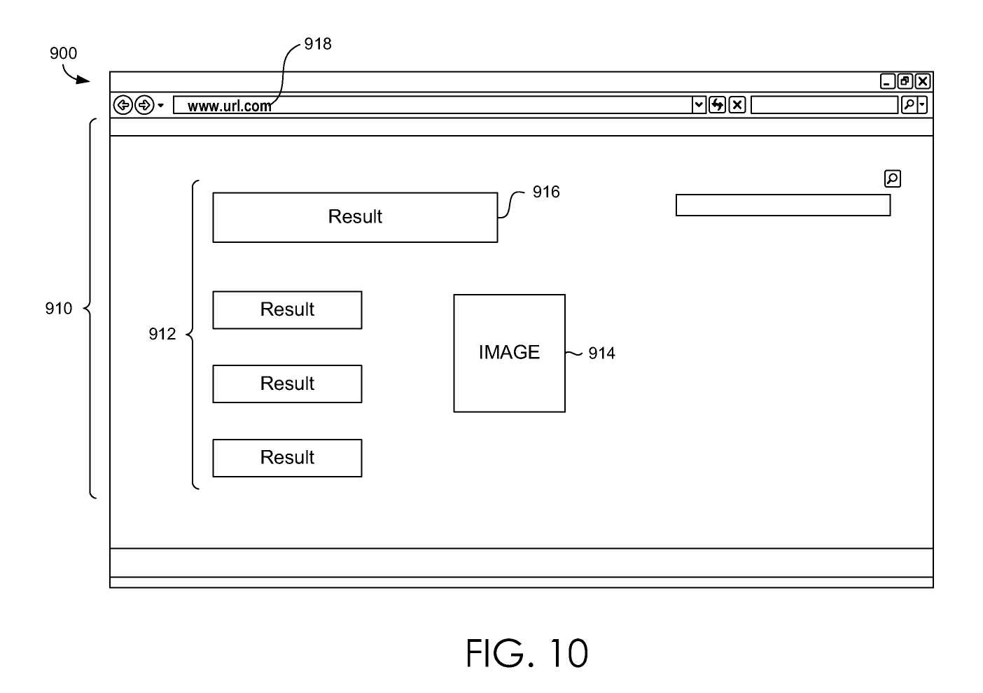

In this example, textual or multimedia search results are supplemented by an image, where the disambiguated query is used to request the image. As an example, see search results 912 and image 914 in FIG. 10, more fully described below. Disambiguated queries can be used to retrieve images, links, advertisements, etc., based on an intended entity. In other words, a more effective query, such as the disambiguated term “Will Smith defensive end,” can be used to request content from an image or multimedia database or a third-party.

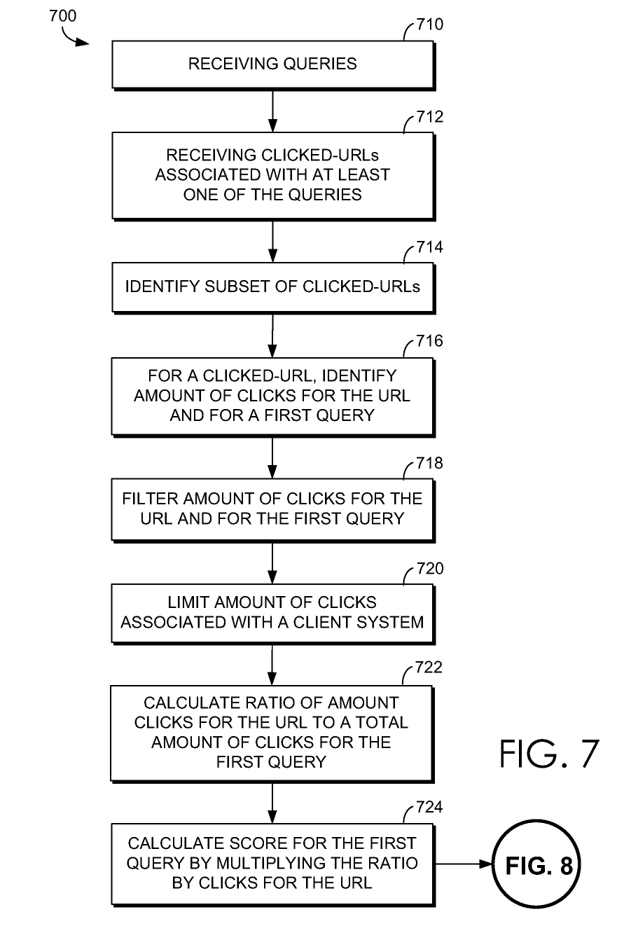

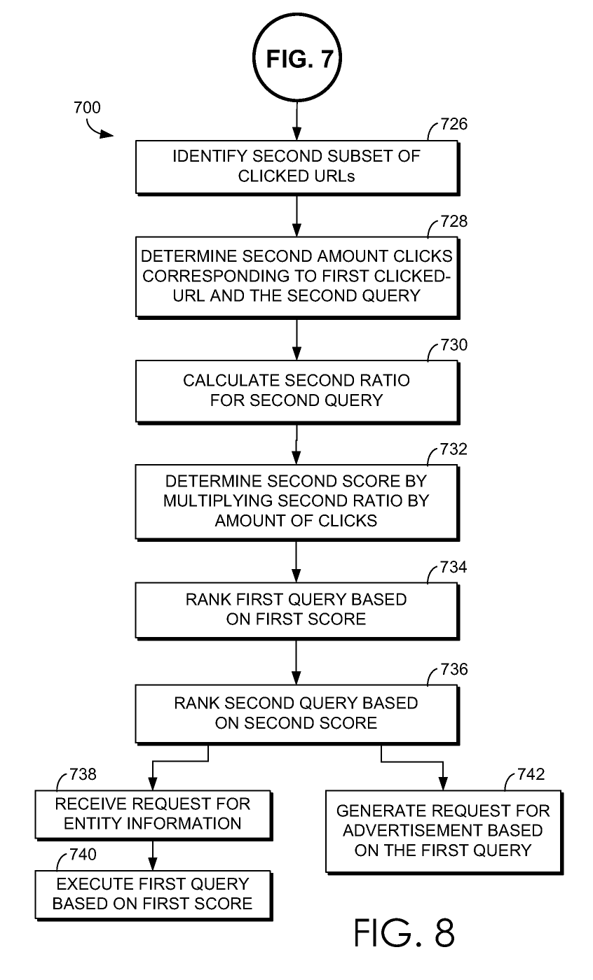

FIGS. 7 and 8 illustrate an exemplary method 700 for identifying search queries, in accordance with an embodiment of the present invention. As indicated at block 710, a plurality of queries, including a first query, is received. As indicated at block 712, a plurality of URL selections is received, where each of the URL selections is associated with at least one query of the plurality of queries. A first subset of URL selections is determined for the first query, as indicated at block 714. A first quantity of user selections that corresponds to a first URL selections and to the first query is determined for the first URL selection of the first subset of URL selections, as indicated at block 716. As indicated at block 718 of an exemplary embodiment shown in FIG. 7, the first quantity of user selections and the first quantity of total user selections are filtered for noise. In an embodiment, the first quantity of user selections and the first quantity of total user selections that are associated with a first client computing system are filtered, as indicated at block 720. For example, the user selections may be filtered to limit, reduce, or preclude the number of user selections that are associated with a first client computing system. As indicated at block 722, a first ratio of the first quantity of user selections to a first quantity of total user selections associated with the first query is determined. As indicated at block 724, a first score for the first query is determined, based on a multiplication of the first ratio by the first quantity of user selections.

The exemplary method 700 in FIG. 8 includes, as indicated at block 726, determining a second subset of URL selections for a different, second query. In an embodiment, the second subset of URL selections also includes the first URL selection referenced above with respect to block 716. For the first URL selection, a second quantity of URL selections that corresponds to the first URL selection and to the second query is determined, as indicated at block 728. A second ratio of the second quantity of user selections to a second quantity of total user selections associated with the second query is determined, as indicated at block 730. A second score for the second query, based on a multiplication of the second ratio by the second quantity of user selections, is determined, as indicated at block 732. The first query is ranked based on the first score (as indicated at block 734), and the second query is ranked based on the second score (as indicated at block 736). In an embodiment, a request is received for information associated with an entity, as indicated at block 738. The first query is executed based on the first score, in one embodiment, as shown at block 740. In an embodiment, a request for an advertisement based on the first query is generated, as indicated at block 742.

FIG. 9 shows an exemplary diagram 800 of data associated with a URL, in accordance with an embodiment of the present invention. The exemplary entity URL 810 is associated with multiple queries (812, 814, 816, 818) based on query information 134. Each query is associated with URL information 820, 822, 824, 826, along with click count information, as shown by the counts 828 (“Count_{1,i}”) and 830 (“Count_{2,i}”), etc. For Query 1, the dedication ratio is shown at 832 (“DedicationRatio_{1,i}”) and the dedication score is shown at 834 (“DedicationScore_{1,i}”).

As described above, for the entity Will Smith (the actor) and the entity Will Smith (football player), the most preferred or most effective query for each of these entities can be determined. By analyzing query information 134 and click count information 136, it can be determined which query is the most likely to lead to the entity Will Smith (football player). For users that clicked on URLs known to be associated with Will Smith (football player), the quantity of user selections can be analyzed, and the underlying queries submitted by the users can be analyzed. By calculating the dedication ratio and the dedication score as described above, it can be determined that the query “Will Smith defensive end” is the most preferred query for obtaining information about the entity Will Smith (football player) in an embodiment of the present invention.

Several search terms or queries for entities can be ambiguous or yield search results associated with more than one entity, even among different types of entities. For example, the query “George Washington” can be ambiguous with respect to the first president of the United States and the university with the same name. In another example, the query “Hotel California” can be ambiguous with respect to the song by that title and the move with the same name. In some cases, only one possible interpretation may be associated with an entity that is a proper noun. Embodiments of the present invention can be used to determine the most preferred or most highly-ranked query for the entity that is a proper noun (or, alternatively, for a non-proper noun entity). For example, the search term “tide” could be associated with the natural phenomenon of the ocean tides or the laundry detergent, Tide®.

In embodiments, the query information 134 and the click count information 136 can continually be updated based on new information, in order to provide dynamic dedication ratios and scores. In embodiments, any clicks that are associated with an overriding of, or a disagreement with, the most preferred query for an entity can be used as feedback to update ratios and scores (and can be weighted with respect to one user or client device, with respect to users in a certain area or that fulfill certain other criteria, or with respect to all users). Embodiments of the present invention can designate areas or users as affected by language-based nuances or preferences, which can affect the scores or the weighting of scores when determining preferred queries. In one example, clicks by certain users are weighted based on demographic information, such as commonalities with a current user, such as being in the same age group or of the same gender.

Queries or search terms may also be weighted or otherwise affected by additional criteria during use of embodiments of the invention. For example, queries can be weighted by length, uniqueness, amount of languages used, reading level, or the presence or strength of additional terms. In embodiments, a query or search term can be one word in length or consist of more than one word, including phrases, distinct terms, and/or numerical or non-alpha-based characters.

Embodiments of the present invention include determinations by computing device 110 regarding preferred or effective query information. Effective queries can be the most likely to lead to a link relating to the correct entity, or a photo or image relating to the entity, and the queries can be used to identify advertising opportunities for product or service entities (or location or title-based entities, such as cities to visit and books or movies to purchase). In embodiments, the preferred or optimized query information can be obtained without the need to crawl content on web pages, saving server time and energy.

An optimal query can be used to generate images for further selection by a user who is searching for an entity, or to generate a photo or image for display next to a search result. For example, during a search for Will Smith and any football associated term (such as a search for “Will Smith football”), the preferred query “Will Smith defensive end” could be used to request a link to content, an image of Will Smith, or an advertisement related to Will Smith (football player). The queries can be used to create a disambiguation page or index, or to cluster relevant results close to each other or in an organized manner.

FIG. 10 shows an exemplary display 900 based on interface components, in accordance with an embodiment of the present invention. In embodiments, a server-side program or application generates or provides interface components that can cause the display 900. An exemplary screen shot 910 includes search results 912 and an image 914. Screen shot 910 can also include a prevalent result 916, which can be based on a refined query that was determined to be a preferred query. The prevalent result 916 can be an image, a first or prominently-displayed link, a launched web page, or a suggested search. The prevalent result 916 is based on the highest scoring query, according to an embodiment. A browser may communicate a display to a client computer and/or a user based on the interface components from the computing device 110. The top result 916 and/or an image 914 can be processed or displayed as a user types or begins to enter text. The screen shot 910 in FIG. 10 includes a URL, as shown at 918. In embodiments, a web address, locator, or URL can include the prefix “http,” “https,” or “www,” or the URL can comprise simply the “url.com” portion of the address.

In an exemplary embodiment, a search has been executed by a user, which returned search results 912. The top or prominent search result 916 can be based on a disambiguated query. In an embodiment, image 914 is based on the disambiguated query, while the remaining search results 912 are based on the ambiguous or original query. The entity URL 810 in FIG. 9 can be used to disambiguate the query, and highest or most effective disambiguated query, such as “Q₁,” can be used based on its dedication score 834.

As can be understood, embodiments of the present invention provide systems and methods for disambiguating entity names. The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the exemplary methods of FIGS. 2 through 9 are not meant to limit the scope of embodiments of the present invention in any way and, in fact, the steps may occur in a variety of different sequences within embodiments hereof and may include less or more steps than those illustrated herein. Any and all such variations, and any combination thereof, are contemplated to be within the scope of embodiments of the present invention.

What is claimed is:

1. A system for associating search terms with entities, the system comprising:
an entity-receiving component that receives a plurality of entities;
an address-receiving component that receives a plurality of addresses, each of the plurality of addresses being associated with one of the plurality of entities;
a logging component that logs one or more submitted search terms and one or more user selections; and
an associating component that associates a first search term of the plurality of search terms with a first entity of the plurality of entities based on the one or more user selections.

2. The system of claim 1, wherein the logging component further logs a quantity of the one or more user selections.

3. The system of claim 2, wherein each of the one or more user selections is a selection of one of the plurality of addresses

4. The system of claim 3, wherein the logging component further logs a quantity of user selections for each of the plurality of addresses.

5. The system of claim 4, wherein the logging component further logs a user associated with each of the one or more user selections, and wherein the quantity of user selections for each of the plurality of addresses includes a maximum number of user selections associated with a particular user.

6. The system of claim 1, wherein at least a portion of the plurality of entities each comprises a proper noun.

7. The system of claim 1, further comprising an information selection component that utilizes the first search term to select information for display.

8. One or more computer-readable storage media storing computer-useable instructions that, when used by one or more computing devices, cause the one or more computing devices to perform a method for selecting a disambiguated name for an entity, the method comprising:
receiving a plurality of web pages, each of at least a portion of the plurality of web pages being associated with a respective entity of a plurality of entities;
receiving a plurality of search queries, each of at least a portion of the plurality of search queries being associated with a respective one of the plurality of web pages;
determining that a first search query of the plurality of search queries is associated with a first entity based on one or more user selections of an associated web page of the plurality of web pages in response to execution of the first search query;
ranking the first search query as the highest ranked search query associated with the first entity;
storing said first search query as the disambiguated name for the first entity.

9. The one or more computer-readable storage media of claim 8, further comprising using said first search query to retrieve an image for display.

10. The one or more computer-readable storage media of claim 8, wherein the one or more user selections are weighted.

11. The one or more computer-readable storage media of claim 8, wherein determining that the first search query of the plurality of search queries is associated with the first entity is based on a quantity of user selections of the web page associated with the first entity compared to a quantity of user selections of other web pages associated with the first search query combined with the quantity of user selections of the web page associated with the first entity.

12. The one or more computer-readable storage media of claim 8, wherein each of at least a portion of the plurality of entities is referred to by one or more proper names.

13. The one or more computer-readable storage media of claim 12, wherein at least a portion of the plurality of entities is selected from a group consisting of: people, places, characters, titles, slogans and products.

14. One or more computer-readable storage media storing computer-useable instructions that, when used by one or more computing devices, cause the one or more computing devices to perform a method for identifying one or more search queries, the method comprising:
receiving a plurality of queries including a first query;
receiving a plurality of URL selections, each of the plurality of URL selections being associated with at least one query of the plurality of queries;
for the first query, determining a first subset of URL selections;
for a first URL selection of the first subset of URL selections, determining a first quantity of URL selections that correspond to the first URL selection and to the first query; and
determining a first ratio of the first quantity of URL selections to a total quantity of URL selections associated with the first query.

15. The one or more computer-readable storage media of claim 14, further comprising filtering the first quantity of URL selections and the total quantity of URL selections for noise.

16. The one or more computer-readable storage media of claim 14, further comprising filtering the first quantity of URL selections and the total quantity of URL selections that are associated with a first client computing system.

17. The one or more computer-readable storage media of claim 14, further comprising determining a first score for the first query, based on a multiplication of the first ratio and the first quantity of URL selections.

18. The one or more computer-readable storage media of claim 17, further comprising:
for a second query, determining a second subset of URL selections, wherein the second subset of URL selections also includes the first URL selection;
for the first URL selection, determining a second quantity of user selections that corresponds to the first URL selection and to a second query;
determining a second ratio of a second quantity of user selections to a second quantity of total URL selections associated with the second query;
determining a second score for the second query, based on a multiplication of the second ratio and the second quantity of URL selections;
ranking the first query based on the first score; and
ranking the second query based on the second score.

19. The one or more computer-readable storage media of claim 18, further comprising:
receiving a request for information associated with an entity; and
executing the first query based on the first score.

20. The one or more computer-readable storage media of claim 18, further comprising generating a request for an advertisement based on the first query.
